(19) United States
(12) Patent Application Publication
(10) Pub. No.: US 2007/0161278 A1
(43) Pub. Date: Jul. 12, 2007

(54) POWER ADAPTER WITH OPTIONAL TYPES OF REPLACEABLE PLUG

(75) Inventors: Lich-Chyum Yen, Taipei City (TW); Chung-Yi Pai, Taipei City (TW); Wen-Chi Huang, Taipei City (TW)

Correspondence Address: TROXELL LAW OFFICE PLLC;SUITE 1404, 5205 LEESBURG PIKE, FALLS CHURCH, VA, 22041, US

(73) Assignee: ATECH TECHNOLOGY CO., LTD.

(21) Appl. No.: 11/329,149

(22) Filed: Jan. 11, 2006

(51) Int. Cl. H01R 27/00

(52) U.S. Cl. 439/222

(57) ABSTRACT

A power supply with optional types of plugs, composed by one universal body and replaceable plug, is disclosed. The universal body consists of a plurality of blocks, a circular recess, an elastic switch key, and two conductive plates; whereas the plugs could be different specifications of plug with opposite blocks and two conductive plates, the block holes and blocks include a set of error-proof block hole and error-proof block which posses a block slot to hold the fan-shaped block, in assembly, one of replaceable plugs could be selected and put its blocs into opposite block holes of circular recess of universal body, then when rotate for fastening, the error-proof block will push fan-shaped block in front of elastic switch key backward, and once the block and error-proof block of plug rotated to preconfigured position, the fan-shaped block will move back to its usual position and insert into the block slot of error-proof block to lock plug firmly without a chance of loosing, while the two conductive plates on the plug contact with conductive plates of universal body to attain the task of replacing plugs with different specification.

### BACKGROUND OF THE INVENTION

The present invention is related to a power adapter with optional types of replaceable plug, especially to a power adapter with technique by aligning the plug block with a mark on universal body and inserting into block holes before rotating to the preconfigured position to attain the purpose of replacing different plugs.

There are various kind of power adapter's plug, such as American specification, European specification, English specification, and Australian specification, etc. shown by FIGS. 1, 2, 3, 4. conventional power supply adapter with replaceable plug in current market is designed into two parts: universal body and various specification plugs, then combine one of the plugs with universal body into a whole power adapter to meet the requirement of options between several replaceable plugs, furthermore conventional power adapter usually apply slide rail or slide slot with conductive plate to assemble different plugs with universal body which always loose the connection part. Therefore, the connection in this way encounters less solidity and safety, and need further improvement.

### SUMMARY OF THE INVENTION

It is therefore a primary object of the present invention to provide a power adapter with optional types of replaceable plug which posses at top blocks around and two conductive plates within, whereas align the blocks with opposite block holes on universal body and insert into the circular recess before rotating to preconfigured position, the fan-shaped block in front of elastic switch key of universal body will insert into the block slots of the plug to lock so that the plug can connect firmly with universal body to prevent plug from loosing off. Pushing elastic switch key backward to move fan-shaped block from the rotary path of the blocks of the plug to take off replaced plug and change another specification of plug.

It is another purpose of the present invention to provide a power adapter with replaceable plug by arranged a set of error-proof block and error-proof block hole among plug blocks and block holes of universal body by different block and block hole shape or attached an identification mark to tell from usual block and block holes for convenient assembly and error proof.

### BRIEF DESCRIPTION OF THE DRAWINGS

FIG. 1 is a perspective view of a plug according to the present invention with American specification;

FIG. 2 is a perspective view of a plug according to the present invention with European specification;

FIG. 3 is a perspective view of a plug according to the present invention with English specification;

FIG. 4 is a perspective view of a plug according to the present invention with Australian specification;

FIG. 5 is a perspective view of a lower part in accordance with the present invention;

FIG. 6 is another view of the lower part in accordance with the present invention;

FIG. 7 is a perspective view of an embodiment with an American specification plug in accordance with the present invention;

FIG. 7A is a lateral cross-sectional view an embodiment with an American specification plug in accordance with the present invention;

FIG. 8 is a perspective view of an embodiment with a European specification plug in accordance with the present invention;

FIG. 8A is a lateral cross-sectional view an embodiment with a European specification plug in accordance with the present invention;

FIG. 8B is an explosive view of an embodiment with a European specification plug in accordance with the present invention;

FIG. 9 is a perspective view of an embodiment with a English specification plug in accordance with the present invention;

FIG. 9A is a lateral cross-sectional view an embodiment with a English specification plug in accordance with the present invention;

FIG. 10 is a perspective view of an embodiment with an Australian specification plug in accordance with the present invention;

FIG. 10A is a lateral cross-sectional view an embodiment with an Australian specification plug in accordance with the present invention;

FIG. 11 is an explosive view of an embodiment with an American specification plug and a lower part in accordance with the present invention;

FIG. 12 is an assembling view of the embodiment in FIG. 11;

FIG. 13 is a first schematic drawing showing the assembling process of an embodiment in accordance with the present invention;

FIG. 14 is a second schematic drawing showing the assembling process of an embodiment in accordance with the present invention;

FIG. 15 is a third schematic drawing showing the assembling process of an embodiment in accordance with the present invention;

FIG. 16 is a fourth schematic drawing showing the assembling process of an embodiment in accordance with the present invention;

FIG. 17 is a fifth schematic drawing showing the assembling process of an embodiment in accordance with the present invention.

### DETAILED DESCRIPTION OF THE PREFFERED EMBODIMENT

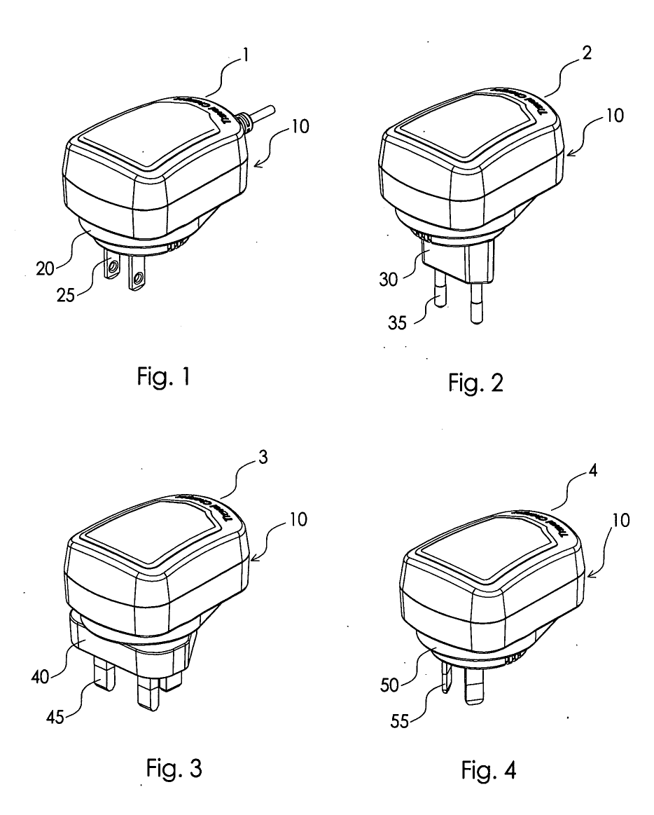

FIG. 1-FIG. 4 shown power supply with different plug specifications 1, 2, 3, 4, which share an universal body 10 designed to accept different specifications of replaceable plug shown by FIGS. 1, 2, 3, 4 as US, European, English, and Australia specification 20, 30, 40, 50 one of which were selected to combine with universal body into a whole power supply unit.

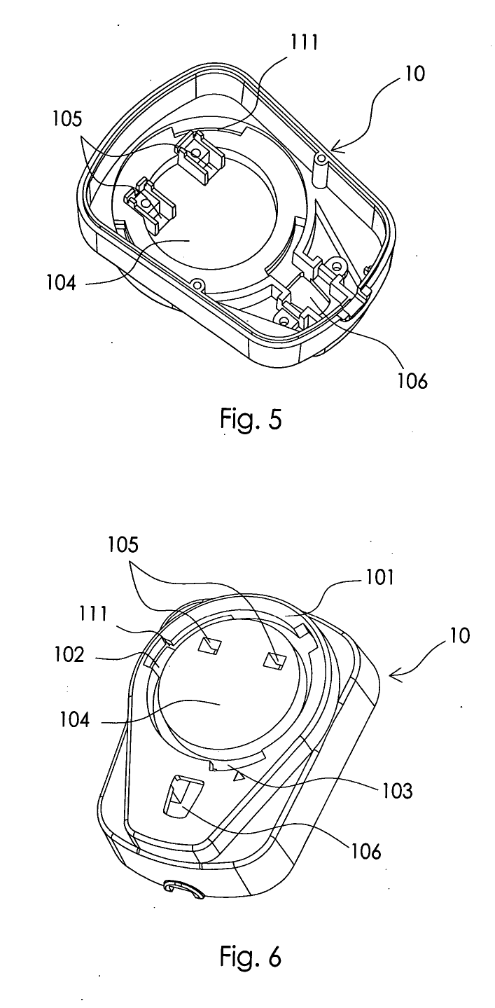

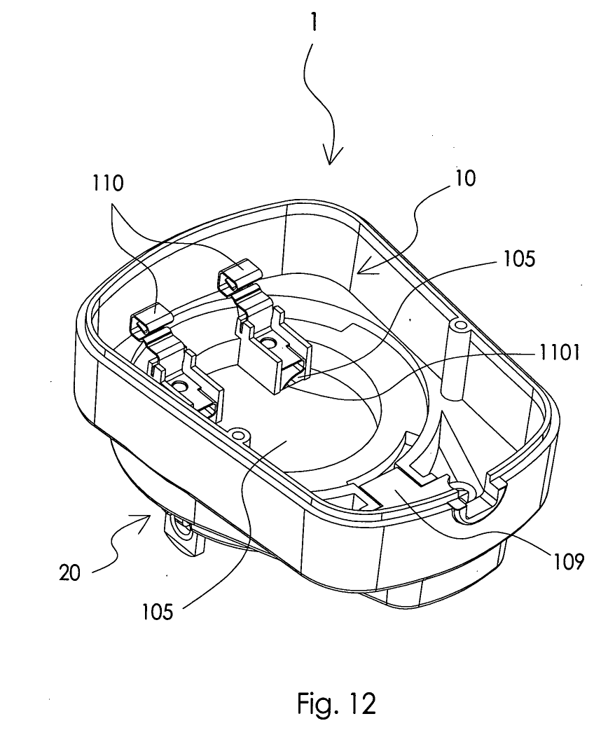

Refer to FIGS. 5, 6, 11, 12, the universal body 10 primarily combined from upper part and lower part with any outer shape, whereas the bottom of universal body 10 (lower part) set up a circular convex edge 101 with a plurality of connection slots 102 around the edge, included an error-proof slot 103 which is different from the other slots 102 and with an “Δ” identification mark 112 for convenient and error-proof assembly. An inner surface 104 set up within the circular edge 101 to form an inner circular slot 111 to act as the rotary path of the plug block hole.

Furthermore, two symmetry openings 105 fixed on the surface of inner surface 104 to accept the conductive surface end 1101 of the metal conductive plate 110 which is a little bit convex from the inner surface 104; switch opening 106 set up at the back of the circular convex edge 10 to hold the control panel 1071 of switch key 107 which is fixed at the outer edge of error-proof block hole 103 with fan-shaped block 1072 in front end and elastic piece 108 like spring fixed at the back end. Switch key 107, pressed fan-shaped block 1072 toward circular recess 11 by the force of elastic piece 108, locates at the rotary path of the error-proof block hole 23 (33, 43, 53) of replaceable plug 20 (30, 40, 50). Switch key 107 convexed from switch key opening 106 can be pressed backward by pressing the control panel 1071 to make fan-shaped block 1072 elastic from rotary path of error-proof block hole 23 (33, 43, 53) and switch key 107, fastened by a fixed plate 109 at the bottom cover, will elastic back when the pressure release.

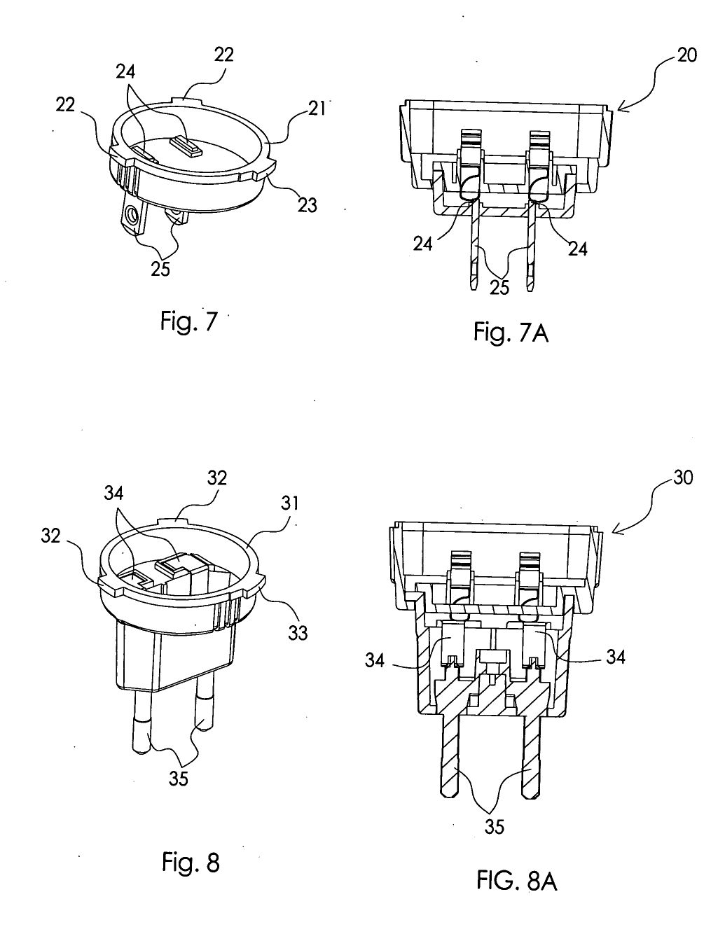

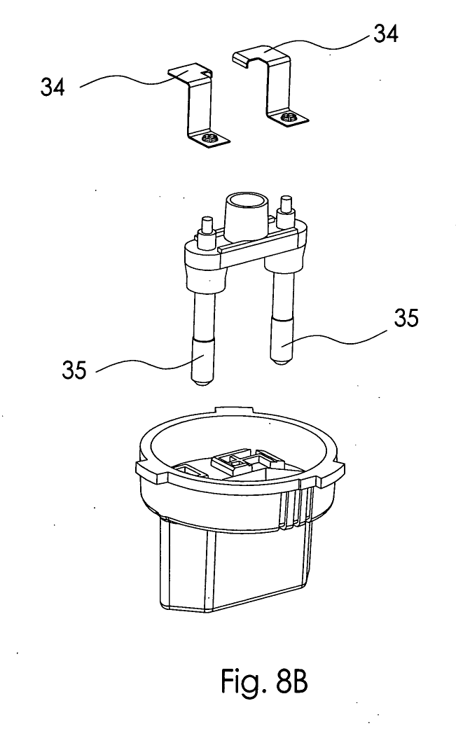

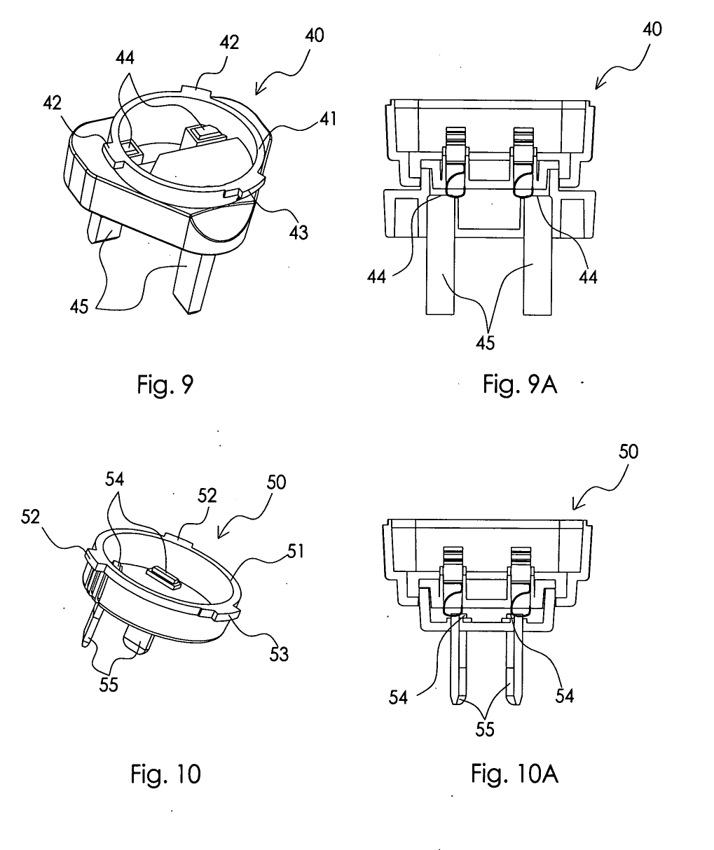

Refer to FIG. 7˜12, at each top of respective replaceable plug 20, 30, 40, 50 set up a circular recess surface 21, 31, 41, 51 which posses block 22, 32, 42, 52 and error-proof block 23, 33, 43, 53 opposite to block hole 102 and error-proof block hole 103 of universal body, whereas the shape of error-proof block should match with the error-proof hole and different from the shape of other block to prevent from mess, or put an attached identification mark “Δ” 26, 36, 46, 56 on the error-proof block for convenient assembly purpose(i.e. error proof when assemble), and at each error-proof block 23, 33, 43, 53 set up a slot 231, 331, 431, 531, and at the lower part of each circular recess surface 21, 31, 41, 51 set up two convex conductive plates 24, 34, 44, 54 opposite to the conductive surface end 1101 of the two symmetry openings 105 of inner surface 104 so that when replaceable plug 20, 30, 40, 50 mounted and rotated to fix position, conductive plate 110 can connect with conductive surface end 1101; at the bottom of various specification of plugs 20, 30, 40, 50 set up different shapes of prongs 25, 35, 45, 55 pertaining to its specification which connect with conductive plates 24, 34, 44, 54 as per FIG. 7A, 8A, 8B, 9A, 10A. The prongs can be built in one solid unit, or two separate parts then connect into one unit.

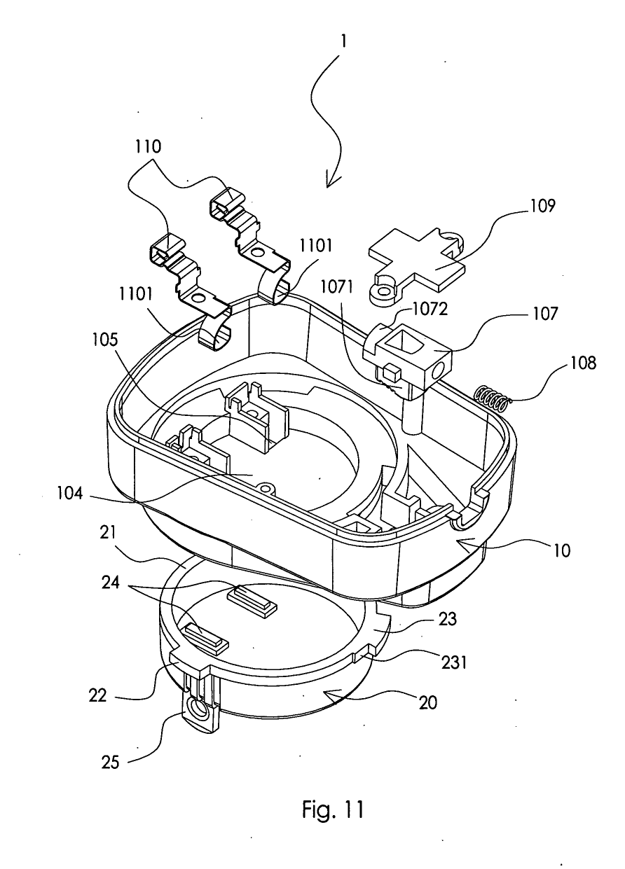

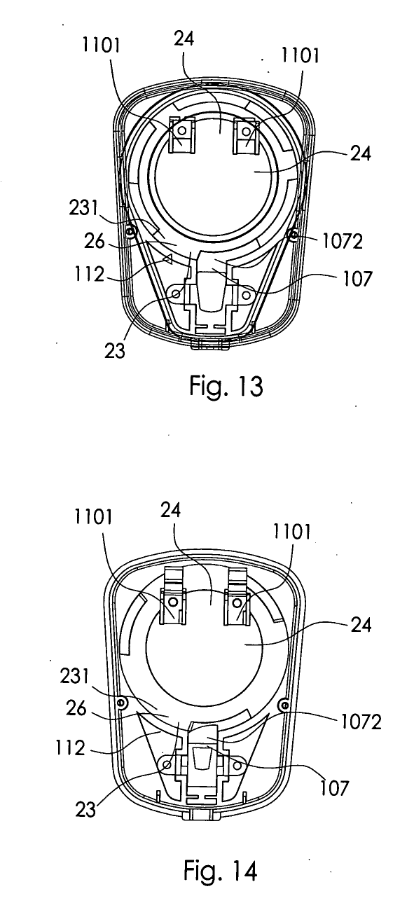

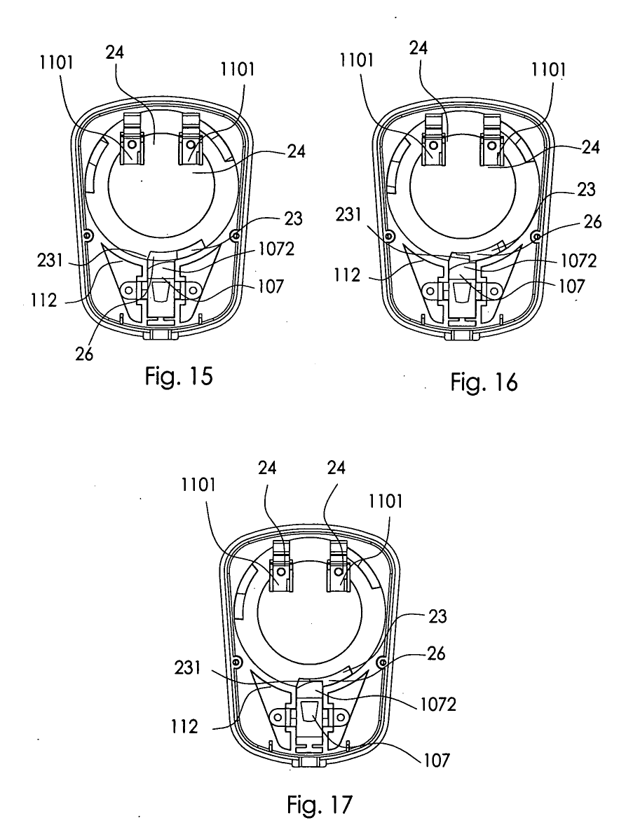

In the process of assembly, select one of the plugs 20, 30, 40, 50, US specification plug 20 for example, refer to FIG. 11, 12 and 13˜17, align mark “Δ” 26 on the plug with mark “Δ” 112 on the circular recess of universal body, then connect error-proof block 23 and blocks 22 of plug 20 with the opposite error-proof block hole 103 and block holes 102 of universal body 10 as per FIG. 13, and make sure the blocks and error-proof blocks insert into the circular recess 111, then rotate the plug 20 as per FIG. 14, 15, 16, owing to the fan-shaped block 1072 in front of elastic switch key 107 convexes at the rotary path of error-proof block 23 will be pressed back by the error-proof block 23 and will move to the block slot 231 of error-proof block 23 by the pressure of the elastic switch key 107 to prevent plug 20 from reverse movement and therefore lock firmly as per FIG. 17 when blocks 22,23 of the plug rotate to the preconfigured position; at the same time, the two conductive plate 24 of plug move to contact with the conductive surface end 1101 of conductive plate of universal body 10 to finish the process of assembly between the plug 20 and the universal body 10. When replace with other type of plug, press the elastic switch key backward by pushing the control panel surface 1071 to loose the fan-shaped block from rotary path of the blocks 22,23 of replaced plug, and reverse the blocks and error-proof block of the plug 20 to the opposite position of blocks' hole 102 and error-proof block hole 103 of the universal body 10, and take off the plug to mount the other type of plug 30, 40, 50 to fulfill the replacement requirement.

1. (canceled)

2. The according to claim 6, wherein an identification mark is located at the block slot of the plug block.

3. The power adapter according to claim 6, wherein the block hole of the universal body, located opposite to the switch opening, is labeled with an identification mark.

4. The power adapter according to claim 6, wherein the prongs of the plug and the conductive plates are built as one solid unit.

5. The power adapter according to claim 6, wherein the prongs of the plug and the conductive plates are two separate parts which are connected into one unit.

6. A power adapter with a replaceable plug comprising a universal body, and a replaceable plug which can be replaced by plugs with various specifications to assemble with the universal body,
wherein the universal body, having a bottom surface with a circular convex edge surrounded by at least two block holes and a recess surface located at the inner lower part of the circular convex edge to form a recess slot between the recess surface and the circular convex edge, the universal body further comprising:
two symmetry openings at the inner surface to allow conductive surface ends of the universal body to convex out,
wherein a switch opening holds a control panel of a switch key which is fixed at an outer edge of an error-proof block hole with a fan-shaped block at a front end of the switch key and an elastic piece fixed at a back end,
wherein the replaceable plug of the switch key including a circular recess surface which has blocks opposite to block holes, and one of several blocks is arranged as a slot, wherein the circular recess surface has two convex conductive plates which are located opposite to the conductive surface ends of the two symmetry openings so that the conductive plates can connect with the conductive surface ends,
wherein plug prongs located on a bottom of the plug are configured to connect with the conductive surface ends respectively,
wherein, when the plug is rotated, the fan-shaped block is configured to move to the position of the block slot and spring into the block slot to thereby lock firmly to prevent the plug from reverse movement while simultaneously, the two conductive plates of the plug move to contact with the conductive surface ends of conductive plate of the universal body to transmit electricity.
